(19) United States
(12) Patent Application Publication
(10) Pub. No.: US 2026/0216819 A1
(43) Pub. Date: Jul. 30, 2026

(54) Method for Controlling Welding Apparatus, Controller, and Welding System

(71) Applicant: BEIJING BOTSING TECHNOLOGY CO.,LTD., Beijing (CN)

(72) Inventors: Xiaobing FENG, Beijing (CN); Jia YAN, Beijing (CN); Aiping LIU, Beijing (CN); Ke SUN, Beijing (CN); Hailong LI, Beijing (CN)

(21) Appl. No.: 19/147,324

(22) PCT Filed: Jan. 15, 2024
(86) PCT No.: PCT/CN2024/072371

§ 371 Date: Jul. 11, 2025

(30) Foreign Application Priority Data
Jan. 13, 2023 (CN) 202310065726.2

(51) Int. Cl. B23K 26/044; B23K 26/03; B23K 26/24

(52) U.S. Cl. CPC B23K 26/044; B23K 26/032; B23K 26/24

(57) ABSTRACT

A method for controlling a welding apparatus, including the following steps: an acquisition step of acquiring an image of a groove of a weld seam to obtain a groove image; a first determination step of extracting a laser line; a processing step of at least fitting the laser line to obtain a first function; a second determination step of determining a third function; a third determination step of determining a predicted position of a welding gun when the third function converges to be a gun alignment position of the welding gun, and performing welding; and repeatedly executing the first determination step, the processing step, the second determination step and the third determination step, until the welding of all weld passes of the weld seam is completed. Further provided are a welding controller, and a welding system for executing the control method.

### CROSS-REFERENCE TO RELATED APPLICATION

The present disclosure claims the priority of Chinese Patent Application 2023100657262, filed in the China National Intellectual Property Administration on Jan. 13, 2023, and entitled “Method for Controlling Welding Apparatus, Controller, and Welding System”, the entire contents of which are herein incorporated by reference.

### TECHNICAL FIELD

The present disclosure relates to the field of welding, and in particular to a method for controlling a welding apparatus, a controller, and a welding system.

### BACKGROUND

At present, with the continuous development of welding technology, the thickness of a plate to be welded gradually increases as well. For the welding of a medium-thickness plate, a groove is wide and deep, and thus multi-layer and multi-pass welding needs to be performed.

However, after the welding of each layer and each pass is performed, it is necessary to manually adjust the position of a welding gun to an appropriate position of the next layer and the next pass, resulting in poor adaptive ability of the welding, and it is impossible to determine an accurate gun alignment position.

Therefore, there is an urgent need for a welding gun locating solution applied to the welding of medium-thickness plates.

The above information disclosed in the background art is only used to enhance the understanding of the background art of the technology described herein, therefore the background art may include certain information, which is not known prior art in China for those skilled in the art.

### SUMMARY

According to one aspect of embodiments of the present disclosure, provided is a method for controlling a welding apparatus, including: an acquisition step of acquiring an image of a groove of a weld seam to obtain a groove image; a first determination step of extracting a laser line according to the groove image, wherein the laser line is a line formed by projecting linear structured light on the weld seam; a processing step of at least fitting the laser line to obtain a first function; a second determination step of determining a third function according to the first function and a second function, wherein the second function is a distance measurement function between a theoretical position and a predicted position of a welding gun, the third function is a loss function between the predicted position and the theoretical position of the welding gun, and the theoretical position is a theoretical position of the welding gun for welding a current weld pass of the groove; a third determination step of determining the predicted position of the welding gun when the third function converges to be a gun alignment position of the welding gun, and performing welding according to the gun alignment position of the welding gun; and repeatedly executing the first determination step, the processing step, the second determination step and the third determination step, until the welding of all weld passes of the weld seam is completed.

Optionally, extracting the laser line according to the groove image includes: determining the theoretical position according to the groove image and weld pass distribution information, wherein the weld pass distribution information is preset weld layer and pass information; and determining that a region including the laser line and the theoretical position is a Region of Interest (ROI).

Optionally, the processing step includes: when the optical axis of an image collection device is perpendicular to the weld seam, fitting the laser line to obtain the first function, wherein the image collection device is configured to acquire the groove image; and when the optical axis of the image collection device is not perpendicular to the weld seam, fitting the laser line to obtain a first preparation function, and then performing affine transformation on the first preparation function to obtain the first function.

Optionally, determining the third function according to the first function and the second function includes: determining the third function according to a formula L(x)=|ƒ′(x)|+αD(x−\hat{x}), wherein L(x) is the third function, ƒ(x) is the first function, α is a weight coefficient, D(x−\hat{x}) is the second function, x is the predicted position of the welding gun, and \hat{x} is the theoretical position of the welding gun.

Optionally, the method further includes: in a case that the theoretical position and the gun alignment position of the welding gun are located on different weld passes, performing assignment on the third function; and in a case that the theoretical position and the gun alignment position of the welding gun are located on the same weld pass, determining whether to update the gun alignment position of the welding gun according to a derivative minimum value of the first function.

Optionally, in a case that the theoretical position and the gun alignment position of the welding gun are located on different weld passes, performing assignment on the third function includes: in a case that x>\hat{x}+d or x<\hat{x}−d, performing assignment on the third function according to a formula L(x)=Lₘₐₓ, wherein x is the gun alignment position of the welding gun, \hat{x} is the theoretical position of the welding gun, d is a distance between adjacent weld passes, L(x) is the third function, and Lₘₐₓ is any numerical value greater than a minimum value of the third function.

Optionally, in a case that the theoretical position and the gun alignment position of the welding gun are located on the same weld pass, determining whether to update the gun alignment position of the welding gun according to the derivative minimum value of the first function includes: in a case that the derivative minimum value of the first function is less than a threshold value, updating the gun alignment position of the welding gun according to a formula \hat{x}′=arg min ƒ′(x), wherein \hat{x}′ is an updated gun alignment position of the welding gun, and ƒ(x) is the first function; and in a case that the derivative minimum value of the first function is greater than or equal to the threshold value, not updating the gun alignment position of the welding gun.

Optionally, performing welding according to the gun alignment position of the welding gun includes: converting a first coordinate into a second coordinate, wherein the first coordinate is a coordinate of the gun alignment position of the welding gun in an image coordinate system, and the second coordinate is a coordinate of the gun alignment position of the welding gun in a welding gun coordinate system; and controlling the welding gun to move to the second coordinate for welding.

According to another aspect of the embodiments of the present disclosure, further provided is a controller for a welding apparatus, including: an acquisition component, configured to perform an acquisition step to acquire an image of a groove of a weld seam, so as to obtain a groove image; a first determination component, configured to perform a first determination step to determine an ROI of a theoretical position according to the groove image, wherein the theoretical position is a theoretical position of a welding gun for welding a current weld pass of the groove, the ROI at least includes a laser line, and the laser line is emitted from a laser sensor of a welding apparatus and is formed by aligning the laser of the groove; a processing component, configured to perform a processing step to at least fit the laser line to obtain a first function; a second determination component, configured to perform a second determination step to determine a third function according to the first function and a second function, wherein the second function is a distance measurement function between the theoretical position and a predicted position of the welding gun, and the third function is a loss function between the predicted position and the theoretical position of the welding gun; a third determination component, configured to perform a third determination step to determine the predicted position of the welding gun when the third function converges to be a gun alignment position of the welding gun, and perform welding according to the gun alignment position of the welding gun; and an execution component, configured to repeatedly execute the first determination step, the processing step, the second determination step and the third determination step, until the welding of all weld passes of the weld seam is completed.

According to still another aspect of the embodiments of the present disclosure, further provided is a welding system, including: any welding apparatus; and a controller, in communication connection with the welding apparatus and configured to execute any control method.

### BRIEF DESCRIPTION OF THE DRAWINGS

The drawings, which constitute a part of the present disclosure, are used to provide a further understanding of the present disclosure, and schematic embodiments of the present disclosure and descriptions thereof are used to explain the present disclosure, and do not constitute an improper limitation on the present disclosure. In the drawings:

FIG. 1 illustrates a flowchart of a method for controlling a welding apparatus according to Embodiment 1 of the present disclosure;

FIG. 2 illustrates a groove image collected during welding according to Embodiment 1 of the present disclosure;

FIG. 3 illustrates a schematic diagram of laser line fitting and a gun alignment position in an ROI according to Embodiment 1 of the present disclosure;

FIG. 4 illustrates a schematic diagram of an ROI of a theoretical position according to Embodiment 1 of the present disclosure;

FIG. 5 illustrates a schematic flowchart of a method for controlling a welding apparatus according to Embodiment 8 of the present disclosure; and

FIG. 6 illustrates a schematic structural diagram of a controller for a welding apparatus according to Embodiment 9 of the present disclosure.

### DETAILED DESCRIPTION OF THE EMBODIMENTS

It should be noted that, if there is no conflict, embodiments in the present disclosure and features in the embodiments may be combined with each other. Hereinafter, the present disclosure will be described in detail with reference to the drawings and in conjunction with the embodiments.

In order to enable those skilled in the art to better understand the solutions of the present disclosure, the technical solutions in the embodiments of the present disclosure will be clearly and completely described below in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

It should be noted that, the terms “first”, “second” and the like in the specification, the claims and the above drawings of the present disclosure are used for distinguishing similar objects, and are not necessarily used for describing a specific sequence or precedence order. It should be understood that data used in this way may be interchanged under appropriate circumstances, so that the embodiments of the present disclosure are described herein. In addition, the terms “including” and “having”, and any variations thereof are intended to cover non-exclusive inclusions, for example, processes, methods, systems, products or devices including a series of steps or components are not necessarily limited to those clearly listed steps or components, but may include other steps or components that are not clearly listed or are inherent to these processes, methods, products or devices.

As stated in the background art, the locating of a welding gun is inaccurate during the welding of a medium-thickness plate in the prior art. In order to solve the above problem, in a typical implementation of the present disclosure, a method for controlling a welding apparatus, a controller for a welding apparatus and a welding system are provided.

### Embodiment 1

According to Embodiment 1 of the present disclosure, a method for controlling a welding apparatus is provided.

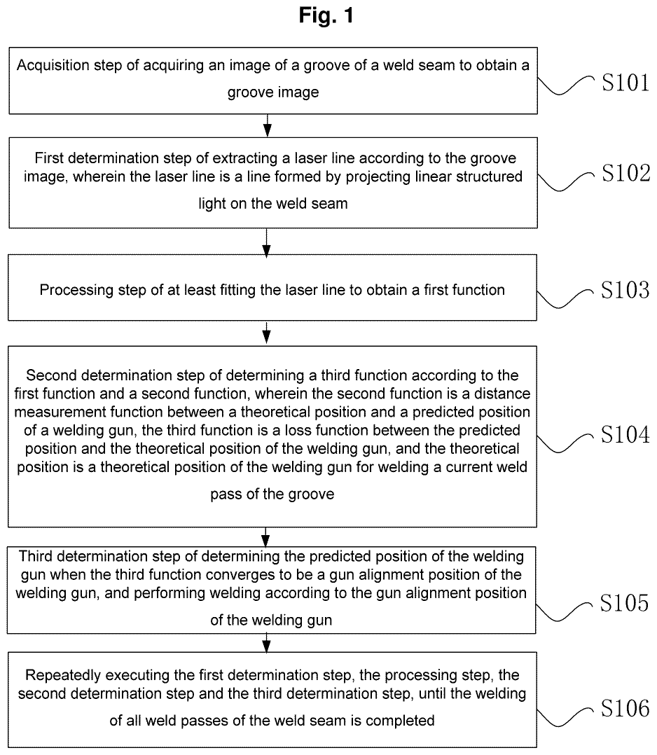

FIG. 1 is a flowchart of a method for controlling a welding apparatus according to Embodiment 1 of the present disclosure. As shown in FIG. 1, the method includes the following steps:

Step S101: an acquisition step of acquiring an image of a groove of a weld seam to obtain a groove image.

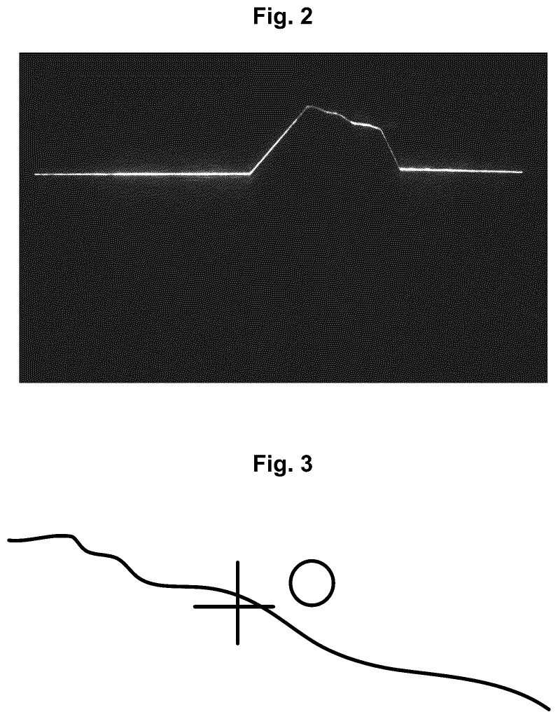

In the above step, the groove refers to a trench that has a certain geometric shape and is formed by machining and assembling parts to be welded of a weldment in a welding process, and the groove may improve the welding degree of the weldment. In actual applications, the image of the groove may be acquired by using an image collection device, for example, a camera, a vidicon, a device having a photographing function, and the like. A three-dimensional linear structured light imaging system may also be used to acquire the groove image in real time in the welding process and scan the three-dimensional morphology of the groove, and FIG. 2 illustrates the groove image collected during welding.

Step S102: a first determination step of extracting a laser line according to the groove image, wherein the laser line is a line formed by projecting linear structured light on the weld seam.

In the above step, the laser line may be quickly acquired according to the groove image.

Step S103: a processing step of at least fitting the laser line to obtain a first function.

In the above step, since there is an error or other interference in the laser line in an ROI, denoising and center line extraction may be performed on the laser line, so as to further improve the accuracy of fitting. Then, the laser line is fitted by using a high-order polynomial least square method. Those skilled in the art may also process the laser line in other manners to eliminate errors and fit the laser line.

Step S104: a second determination step of determining a third function according to the first function and a second function, wherein the second function is a distance measurement function between a theoretical position and a predicted position of a welding gun, the third function is a loss function between the predicted position and the theoretical position of the welding gun, and the theoretical position is a theoretical position of the welding gun for welding a current weld pass of the groove.

In the above step, the loss function is determined according to the distance measurement function and a laser line fitting function, so that complex operation steps are reduced, and the manner is simple and convenient; and in addition, the distance measurement function is a good similarity measurement standard.

Step S105: a third determination step of determining the predicted position of the welding gun when the third function converges to be a gun alignment position of the welding gun, and performing welding according to the gun alignment position of the welding gun.

In the above step, the loss function is used for estimating the inconsistency between a predicted value and a true value of a model, and the smaller the loss function is, the better the robustness of the model is. Therefore, when the third function converges, the predicted position of the corresponding welding gun is an optimal gun alignment position. In the welding process of welding the current weld pass, the groove image is acquired in real time, the laser line is extracted according to the groove image acquired in real time, and the gun alignment position of the welding gun is determined. The welding gun may accurately weld the current weld pass according to the optimal gun alignment position. The calculated optimal gun alignment position may be subjected to various types of interference, and there is high-frequency skip, but an actual optimal gun alignment position should smoothly change in an actual scanning process in fact. Therefore, after the optimal gun alignment position is calculated in real time, high-frequency noise can be eliminated by smoothing filtering, to obtain a more accurate gun alignment position. As shown in FIG. 3, it illustrates laser line fitting and the optimal gun alignment position in the ROI, wherein the black curve is a first function curve, the circle is the theoretical position, the cross is the calculated gun alignment position, and the optimal gun alignment position is the most smooth position of the first function curve.

Step S106: repeatedly executing the first determination step, the processing step, the second determination step and the third determination step, until the welding of all weld passes of the weld seam is completed.

In the above step, after the welding of the current weld pass is completed, the above steps are cyclically executed, and by continuously collecting and analyzing the groove image and dynamically adjusting the position of the welding gun, it can be guaranteed that the welding gun is always at the optimal gun alignment position in the welding process. When the welding of the current weld pass is completed and a robot returns to an initial position to perform the welding of the next weld pass, a layer and pass accumulator may perform accumulation, such that an algorithm updates the settings of the current weld pass and selects new preset weld pass distribution information.

In the embodiments of the present disclosure, by acquiring the groove image of the weld seam in real time, the ROI including the theoretical position of a welding spot and the laser line may be determined, the loss function between the theoretical position and the predicted position is determined according to the function of the laser line, that is, the first function, and the distance measurement function between the theoretical position and the predicted position, that is, the second function, and then the gun alignment position of the welding gun is determined according to the predicted position during the convergence of the loss function, thereby achieving the purposes of finding an optimal gun alignment position of the current weld pass in real time and dynamically adjusting the welding gun, and implementing the technical effect of improving the welding quality of multi-layer and multi-pass welding of the medium-thickness plate, thus solving the technical problem of inaccurate locating of the welding gun during welding due to the fact that the welding groove of the medium-thickness plate is wide and deep.

### Embodiment 2

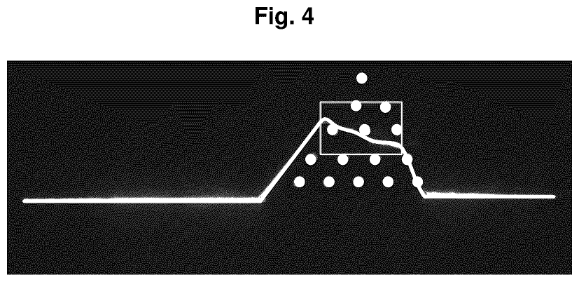

In Embodiment 2 of the present disclosure, on the basis of Embodiment 1, the above step S102 is further specifically refined, and the step specifically includes: step S1021, determining the theoretical position according to the groove image and weld pass distribution information, wherein the weld pass distribution information is preset weld layer and pass information, the preset weld layer and pass information includes the number of the preset weld layers and the number of the preset weld passes; and step S1022, determining that a region including the laser line and the theoretical position is an ROI. The ROI (Region of Interest) refers to a specific region to be processed, which is outlined from a region to be processed in fields such as machine vision and image processing in manners such as a rectangle, a circle, an ellipse and an irregular polygon. In practical applications, for the welding of the medium-thickness plate, since the groove is wide and deep, multi-layer and multi-pass welding needs to be performed on the groove. A welding robot may autonomously plan corresponding preset weld pass distribution information according to the shape of the groove of the weld seam, the welding gun performs welding according to the preset weld pass distribution information, and determines the theoretical position of the welding spot according to the weld pass distribution information, but the theoretical position is not very accurate. Therefore, the ROI may be determined around the theoretical position, as shown in FIG. 4, a rectangular region is the ROI, a dot is the theoretical position corresponding to the welding gun when welding the weld pass of the groove, and a welding spot in the rectangular region is the theoretical position corresponding to the current weld pass. The determination of the ROI is related to the theoretical position and welding characteristics of the current weld pass, wherein the welding characteristics include welding characteristics of a base material, the current and voltage of a welding power supply, and the like. In practical applications, for the welding of the medium-thickness plate, since the groove is wide and deep, multi-layer and multi-pass welding needs to be performed on the groove. The welding robot may autonomously plan corresponding preset weld pass distribution information according to the shape of the groove of the weld seam, and the welding gun performs welding according to the preset weld pass distribution information, and determines the theoretical position of the welding spot according to the weld pass distribution information. By using the above method for determining the ROI, an accurate first function may be further obtained.

### Embodiment 3

In Embodiment 3 of the present disclosure, on the basis of Embodiment 1, the above step S103 is further specifically refined, and the step specifically includes: step S1031, when the optical axis of an image collection device is perpendicular to the weld seam, fitting the laser line to obtain the first function, wherein the image collection device is configured to acquire the groove image; and step S1032, when the optical axis of the image collection device is not perpendicular to the weld seam, fitting the laser line to obtain a first preparation function, and then performing affine transformation on the first preparation function to obtain the first function. In the above steps, an optimal gun alignment position of the welding gun is further related to the horizontality of the current gun alignment position of the welding gun in addition to a theoretical gun alignment position. Generally, the current gun alignment position of the welding gun is a lap joint position of previous cladding and earlier cladding, which may be approximately a horizontal plane. When the optical axis of the image collection device is perpendicular to the weld seam, a curve of the horizontal plane on the image is also horizontal, and the first function may be obtained by fitting the laser line. When the optical axis of the image collection device is not perpendicular to the weld seam, affine transformation may be first performed on a fitting function by a camera calibration result to obtain the first function, wherein the affine transformation refers to performing once linear transformation on one vector space and then performing one translation to convert the vector space into another vector space in geometry. The affine transformation may be performed on the fitting function in manners such as translation, rotation, scaling and beveling.

### Embodiment 4

In Embodiment 4 of the present disclosure, on the basis of Embodiment 1, the above step S104 is further specifically refined, and the step specifically includes: step S1041, L(x)=|ƒ′(x)|+αD(x−\hat{x}) determining the third function according to a formula, wherein L(x) is the third function, ƒ(x) is the first function, α is a weight coefficient, D(x−\hat{x}) is the second function, x is the predicted position of the welding gun, and \hat{x} is the theoretical position of the welding gun. In the above step, the loss function is determined according to the distance measurement function and the laser line fitting function, so that complex operation steps are reduced, and the formula is simple and convenient; and in addition, the distance measurement function is a good similarity measurement standard. In an actual application process, those skilled in the art may autonomously adjust the weight coefficient according to actual situations.

### Embodiment 5

In Embodiment 5 of the present disclosure, on the basis of Embodiment 1, the method further includes: step S107, in a case that the theoretical position and the gun alignment position of the welding gun are located on different weld passes, performing assignment on the third function; and step S108, in a case that the theoretical position and the gun alignment position of the welding gun are located on the same weld pass, determining whether to update the gun alignment position of the welding gun according to a derivative minimum value of the first function. In the above steps, although the farther the gun alignment position of the welding gun is away from the theoretical gun alignment position, the smaller the possibility is, the theoretical position and an actual gun alignment position usually do not exceed the distance of one weld pass, so the above steps can further improve the search accuracy of the optimal gun alignment position under accident situations.

### Embodiment 6

In Embodiment 6 of the present disclosure, on the basis of Embodiment 5, the above step S107 is further specifically refined, and the step specifically includes: step S1071, in a case that x>\hat{x}+d or x<\hat{x}−d, performing assignment on the third function according to a formula L(x)=Lₘₐₓ, wherein x is the gun alignment position of the welding gun, \hat{x} is the theoretical position of the welding gun, d is a distance between adjacent weld passes, L(x) is the third function, and Lₘₐₓ is any numerical value greater than a minimum value of the third function. In the above step, when the calculated distance between the optimal gun alignment position and the theoretical gun alignment position is greater than a theoretical distance between the gun alignment positions on adjacent weld passes, further correction is required. By assigning a greater value to the loss function, when the third function converges, the position is not used as the optimal gun alignment position to correct the situation. The above step may further improve the search accuracy of the optimal gun alignment position in a case that the theoretical position and the gun alignment position position of the welding gun are located on different weld passes.

### Embodiment 7

In Embodiment 7 of the present disclosure, on the basis of Embodiment 5, the above step S108 is further specifically refined, and the step specifically includes: step S1081, in a case that the derivative minimum value of the first function is less than a threshold value, updating the gun alignment position of the welding gun according to a formula \hat{x}′=arg min ƒ′(x) wherein \hat{x}′ is an updated gun alignment position of the welding gun, and ƒ(x) is the first function; and step S1802, in a case that the derivative minimum value of the first function is greater than or equal to the threshold value, not updating the gun alignment position of the welding gun. In the above steps, a derivative threshold value may be set, when the derivative minimum value is less than the threshold value, the optimal gun alignment position is updated, and otherwise, the optimal gun alignment position is not updated. The above steps may further improve the search accuracy of the optimal gun alignment position in a case that the theoretical position and the gun alignment position position of the welding gun are located on the same weld pass.

### Embodiment 8

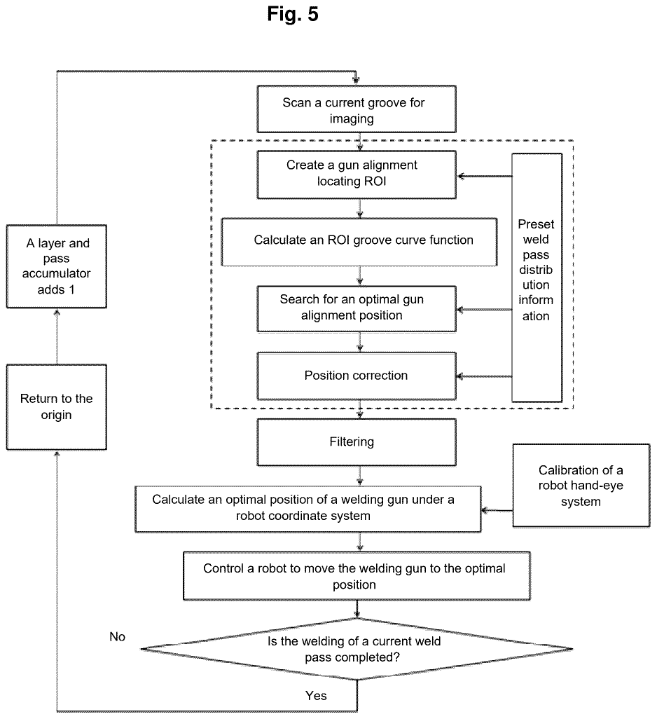

In Embodiment 8 of the present disclosure, on the basis of Embodiment 1, the above step S105 is further specifically refined, and the step specifically includes: step S1051, converting a first coordinate into a second coordinate, wherein the first coordinate is a coordinate of the gun alignment position of the welding gun in an image coordinate system, and the second coordinate is a coordinate of the gun alignment position of the welding gun in a welding gun coordinate system; and step S1052, controlling the welding gun to move to the second coordinate for welding. In the above steps, the coordinate system of the welding gun and the coordinate system of the image collection device belong to two different coordinate systems. The welding gun is a “hand” by analogy, the image collection device is an “eye” in analogy, the optimal gun alignment position is converted into a three-dimensional coordinate by a calibration result of a robot hand-eye system, and the three-dimensional coordinate is converted into a coordinate system of a robot body. The robot is controlled to move the welding gun to the optimal gun alignment position. Then, according to the relationship between the coordinate system of the robot body and the coordinate system of the welding gun, the welding gun is controlled by a robot control system to move to the calculated optimal gun alignment three-dimensional coordinate, to complete the conversion of the coordinate system and complete one locating operation. An overall flowchart of the welding apparatus control method is shown in FIG. 5, a current groove is first scanned for imaging, an ROI is created according to the preset pass distribution information, then a laser line function in the ROI is fitted, the optimal gun alignment position is searched, and if the optimal gun alignment position does not occur on the same weld pass, the position is corrected. In addition, the optimal gun alignment position may also be filtered, the coordinate system of the optimal gun alignment position is converted by the calibration of the robot hand-eye system, the robot is controlled to move the welding gun to the optimal gun alignment position for working, and the welding gun is returned to an initial position. The above steps are repeated until the welding work of all weld passes is completed.

### Embodiment 9

Embodiment 9 of the present disclosure further provides a controller for a welding apparatus. It should be noted that the welding apparatus in the embodiments of the present disclosure may be used for executing the welding apparatus control method provided in the embodiments of the present disclosure. The welding apparatus provided in the embodiments of the present disclosure is described below.

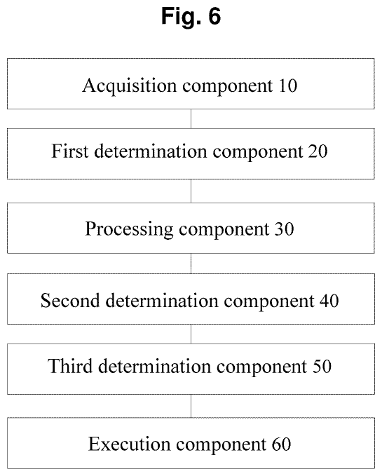

FIG. 6 is a schematic diagram of a controller for a welding apparatus according to Embodiment 9 of the present disclosure. As shown in FIG. 6, the controller includes:

An acquisition component 10, configured to perform an acquisition step to acquire an image of a groove of a weld seam, so as to obtain a groove image.

In the above acquisition component, the groove refers to a trench that has a certain geometric shape and is formed by machining and assembling parts to be welded of a weldment in a welding process, and the groove may improve the welding degree of the weldment. In actual applications, the image of the groove may be acquired by using an image collection device, for example, a camera, a vidicon, a device having a photographing function, and the like. A three-dimensional linear structured light imaging system may also be used to acquire the groove image in real time in the welding process and scan the three-dimensional morphology of the groove, and FIG. 2 illustrates the groove image collected during welding.

A first determination component 20, configured to perform a first determination step to extract a laser line according to the groove image, wherein the laser line is a line formed by projecting linear structured light on the weld seam.

In the above acquisition component, the laser line may be quickly acquired according to the groove image.

A processing component 30, configured to perform a processing step to at least fit the laser line to obtain a first function.

In the above acquisition component, since there is an error or other interference in the laser line in an ROI, denoising and center line extraction may be performed on the laser line, so as to further improve the accuracy of fitting. Then, the laser line is fitted by using a high-order polynomial least square method. Those skilled in the art may also process the laser line in other manners to eliminate errors and fit the laser line.

A second determination component 40, configured to perform a second determination step to determine a third function according to the first function and a second function, wherein the second function is a distance measurement function between a theoretical position and a predicted position of a welding gun, the third function is a loss function between the predicted position and the theoretical position of the welding gun, and the theoretical position is a theoretical position of the welding gun when welding a current weld pass of the groove.

In the above acquisition component, the loss function is determined according to the distance measurement function and a laser line fitting function, so that complex operation steps are reduced, and the manner is simple and convenient; and in addition, the distance measurement function is a good similarity measurement standard.

A third determination component 50, configured to perform a third determination step to determine the predicted position of the welding gun when the third function converges to be a gun alignment position of the welding gun, and perform welding according to the gun alignment position of the welding gun.

In the above acquisition component, the loss function is used for estimating the inconsistency between a predicted value and a true value of a model, and the smaller the loss function is, the better the robustness of the model is. Therefore, when the third function converges, the predicted position of the corresponding welding gun is an optimal gun alignment position. In the welding process of welding the current weld pass, the groove image is acquired in real time, the laser line is extracted according to the groove image acquired in real time, and the gun alignment position of the welding gun is determined. The welding gun may accurately weld the current weld pass according to the optimal gun alignment position. The calculated optimal gun alignment position may be subjected to various types of interference, and there is high-frequency skip, but an actual optimal gun alignment position should smoothly change in an actual scanning process in fact. Therefore, after the optimal gun alignment position is calculated in real time, high-frequency noise can be eliminated by smoothing filtering, to obtain a more accurate gun alignment position. As shown in FIG. 3, it illustrates laser line fitting and the optimal gun alignment position in an ROI, wherein the black curve is a first function curve, the dot is the theoretical position, the cross is the calculated gun alignment position, and the optimal gun alignment position is the most smooth position of the first function curve.

An execution component 60, configured to repeatedly execute the first determination step, the processing step, the second determination step and the third determination step, until the welding of all weld passes of the weld seam is completed.

In the above acquisition component, after the welding of the current weld pass is completed, the above steps are cyclically executed, and by continuously collecting and analyzing the groove image and dynamically adjusting the position of the welding gun, it can be guaranteed that the welding gun is always at the optimal gun alignment position in the welding process. When the welding of the current weld pass is completed and a robot returns to an initial position to perform the welding of the next weld pass, a layer and pass accumulator may perform accumulation, such that an algorithm updates the settings of the current weld pass and selects new preset weld pass distribution information.

In the embodiments of the present disclosure, by acquiring the groove image of the weld seam in real time, the ROI including the theoretical position of a welding spot and the laser line may be determined, the loss function between the theoretical position and the predicted position is determined according to the function of the laser line, that is, the first function, and the distance measurement function between the theoretical position and the predicted position, that is, the second function, and then the gun alignment position of the welding gun is determined according to the predicted position during the convergence of the loss function, thereby achieving the purposes of finding an optimal gun alignment position of the current weld pass in real time and dynamically adjusting the welding gun, and implementing the technical effect of improving the welding quality of multi-layer and multi-pass welding of the medium-thickness plate, thus solving the technical problem of inaccurate locating of the welding gun during welding due to the fact that the welding groove of the medium-thickness plate is wide and deep.

### Embodiment 10

In Embodiment 10 of the present disclosure, on the basis of Embodiment 9, the first determination component is further specifically refined, and the first determination component specifically includes: a first determination module, configured to determine the theoretical position according to the groove image and weld pass distribution information, wherein the weld pass distribution information is preset weld layer and pass information; and a second determination module, configured to determine that a rectangular region including the laser line and the theoretical position is an ROI. In the above apparatus, the ROI (Region of Interest) refers to a specific region to be processed, which is outlined from a region to be processed in fields such as machine vision and image processing in manners such as a rectangle, a circle, an ellipse and an irregular polygon. In practical applications, for the welding of the medium-thickness plate, since the groove is wide and deep, multi-layer and multi-pass welding needs to be performed on the groove. A welding robot may autonomously plan corresponding preset weld pass distribution information according to the shape of the groove of the weld seam, the welding gun performs welding according to the preset weld pass distribution information, and determines the theoretical position of the welding spot according to the weld pass distribution information, but the theoretical position is not very accurate. Therefore, the ROI may be determined around the theoretical position, as shown in FIG. 4, the rectangular region is the ROI, the dot is the theoretical position corresponding to the welding gun when welding the weld pass of the groove, and a welding spot in the rectangular region is the theoretical position corresponding to the current weld pass. The determination of the ROI is related to the theoretical position and welding characteristics of the current weld pass, wherein the welding characteristics include welding characteristics of a base material, the current and voltage of a welding power supply, and the like. In practical applications, for the welding of the medium-thickness plate, since the groove is wide and deep, multi-layer and multi-pass welding needs to be performed on the groove. The welding robot may autonomously plan corresponding preset weld pass distribution information according to the shape of the groove of the weld seam, and the welding gun performs welding according to the preset weld pass distribution information, and determines the theoretical position of the welding spot according to the weld pass distribution information. By using the above method for determining the ROI, an accurate first function may be further obtained.

### Embodiment 11

In Embodiment 11 of the present disclosure, on the basis of the above Embodiment 9, the processing component is further specifically refined, and the processing component specifically includes: a first processing module, configured to: when the optical axis of an image collection device is perpendicular to the weld seam, fit the laser line to obtain the first function, wherein the image collection device is configured to acquire the groove image; and a second processing module, configured to: when the optical axis of the image collection device is not perpendicular to the weld seam, fit the laser line to obtain a first preparation function, and then perform affine transformation on the first preparation function to obtain the first function. In the above apparatus, an optimal gun alignment position of the welding gun is further related to the horizontality of the current gun alignment position of the welding gun in addition to a theoretical gun alignment position. Generally, the current gun alignment position of the welding gun is a lap joint position of previous cladding and earlier cladding, which may be approximately a horizontal plane. When the optical axis of the image collection device is perpendicular to the weld seam, a curve of the horizontal plane on the image is also horizontal, and the first function may be obtained by fitting the laser line. When the optical axis of the image collection device is not perpendicular to the weld seam, affine transformation may be first performed on a fitting function by a camera calibration result to obtain the first function, wherein the affine transformation refers to performing once linear transformation on one vector space and then performing one translation to convert the vector space into another vector space in geometry. The affine transformation may be performed on the fitting function in manners such as translation, rotation, scaling and beveling.

### Embodiment 12

In Embodiment 12 of the present disclosure, on the basis of Embodiment 9, the second determination component is further specifically refined, and the second determination component specifically includes: a fourth determination module, configured to determine the third function according to a formula L(x)=|ƒ′(x)+αD(x−\hat{x}), wherein L(x) is the third function, ƒ(x) is the first function, a is a weight coefficient, D(x−\hat{x}) is the second function, x is the predicted position of the welding gun, and \hat{x} is the theoretical position of the welding gun. In the above apparatus, the loss function is determined according to the distance measurement function and the laser line fitting function, so that complex operation steps are reduced, and the formula is simple and convenient; and in addition, the distance measurement function is a good similarity measurement standard. In an actual application process, those skilled in the art may autonomously adjust the weight coefficient according to actual situations.

### Embodiment 13

In Embodiment 13 of the present disclosure, on the basis of Embodiment 9, the controller further includes: an assignment component, configured to: in a case that the theoretical position and the gun alignment position of the welding gun are located on different weld passes, perform assignment on the third function; and a fourth determination component, configured to: in a case that the theoretical position and the gun alignment position of the welding gun are located on the same weld pass, determine whether to update the gun alignment position of the welding gun according to a derivative minimum value of the first function. In the above apparatus, although the farther the gun alignment position of the welding gun is away from the theoretical gun alignment position, the smaller the possibility is, the theoretical position and an actual gun alignment position usually do not exceed the distance of one weld pass, so the above steps can further improve the search accuracy of the optimal gun alignment position under accident situations.

### Embodiment 14

In Embodiment 14 of the present disclosure, on the basis of Embodiment 13, the assignment component is further specifically refined, and the assignment component specifically includes: an assignment module, configured to: in a case that x>\hat{x}+d or x<\hat{x}−d, performing assignment on the third function according to a formula L(x)=Lₘₐₓ wherein x is the gun alignment position of the welding gun, \hat{x} is the theoretical position of the welding gun, d is a distance between adjacent weld passes, L(x) is the third function, and Lₘₐₓ is any numerical value greater than a minimum value of the third function. In the above apparatus, when the calculated distance between the optimal gun alignment position and the theoretical gun alignment position is greater than a theoretical distance between the gun alignment positions on adjacent weld passes, further correction is required. By assigning a greater value to the loss function, when the third function converges, the position is not used as the optimal gun alignment position to correct the situation. The above step may further improve the search accuracy of the optimal gun alignment position in a case that the theoretical position and the gun alignment position position of the welding gun are located on different weld passes.

### Embodiment 15

In Embodiment 15 of the present disclosure, on the basis of Embodiment 13, the fourth determination component is further specifically refined, and the fourth determination component specifically includes: an updating module, configured to: in a case that the derivative minimum value of the first function is less than a threshold value, update the gun alignment position of the welding gun according to a formula \hat{x}′=arg min ƒ′(x), wherein \hat{x}′ is an updated gun alignment position of the welding gun, and ƒ(x) is the first function; and a third processing module, configured to: in a case that the derivative minimum value of the first function is greater than or equal to the threshold value, not update the gun alignment position of the welding gun. In the above apparatus, a derivative threshold value may be set, when the derivative minimum value is less than the threshold value, the optimal gun alignment position is updated, and otherwise, the optimal gun alignment position is not updated. The above steps may further improve the search accuracy of the optimal gun alignment position in a case that the theoretical position and the gun alignment position position of the welding gun are located on the same weld pass.

### Embodiment 16

In Embodiment 16 of the present disclosure, on the basis of Embodiment 9, the third determination component is further specifically refined, and the third determination component specifically includes: a conversion module, configured to convert a first coordinate into a second coordinate, wherein the first coordinate is a coordinate of the gun alignment position of the welding gun in an image coordinate system, and the second coordinate is a coordinate of the gun alignment position of the welding gun in a welding gun coordinate system; and a control module, configured to control the welding gun to move to the second coordinate for welding. In the above apparatus, the coordinate system of the welding gun and the coordinate system of the image collection device belong to two different coordinate systems. The welding gun is a “hand” by analogy, the image collection device is an “eye” in analogy, the optimal gun alignment position is converted into a three-dimensional coordinate by a calibration result of a robot hand-eye system, and the three-dimensional coordinate is converted into a coordinate system of a robot body. The robot is controlled to move the welding gun to the optimal gun alignment position. Then, according to the relationship between the coordinate system of the robot body and the coordinate system of the welding gun, the welding gun is controlled by a robot control system to move to the calculated optimal gun alignment three-dimensional coordinate, to complete the conversion of the coordinate system and complete one locating operation. An overall flowchart of the welding apparatus control method is shown in FIG. 5, a current groove is first scanned for imaging, an ROI is created according to the preset pass distribution information, then a laser line function in the ROI is fitted, the optimal gun alignment position is searched, and if the optimal gun alignment position does not occur on the same weld pass, the position is corrected. In addition, the optimal gun alignment position may also be filtered, the coordinate system of the optimal gun alignment position is converted by the calibration of the robot hand-eye system, the robot is controlled to move the welding gun to the optimal gun alignment position to complete the welding work of the current weld pass, and the welding gun is returned to an initial position. The above steps are repeated until the welding work of all weld passes is completed.

It should be noted that the steps shown in the flowcharts of the drawings may be executed in a computer system such as a group of computer-executable instructions, and moreover, although a logical order is shown in the flowcharts, in some cases, the steps shown or described may be executed in an order different from that described herein.

The welding apparatus controller includes a processor and a memory, and the acquisition component, the first determination component, the processing component, the second determination component, the third determination component and the execution component are all stored in the memory as program components, and the processor executes the program components stored in the memory to implement corresponding functions.

The processor includes a kernel, and the kernel invokes corresponding program components from the memory. One or more kernels may be provided, and the optimal gun alignment position is determined by adjusting parameters of the kernel.

The memory may include a volatile memory, a random access memory (RAM), and/or a non-volatile memory in a computer-readable medium, for example, a read-only memory (ROM) or a flash RAM, and the memory includes at least one storage chip.

### Embodiment 17

An embodiment of the present disclosure provides a welding system, including a welding apparatus, a controller, a processor, a memory, and a program stored on the memory and executable on the processor, wherein the processor, when executing the program, implements at least the following steps:
Step S101: an acquisition step of acquiring an image of a groove of a weld seam to obtain a groove image;
Step S102: a first determination step of determining an ROI of a theoretical position according to the groove image, wherein the theoretical position is a theoretical position of a welding gun for welding a current weld pass to the groove, the ROI at least includes a laser line, and the laser line is emitted from a laser sensor of the welding apparatus and is formed by aligning the laser of the groove;
step S103: a processing step of at least fitting the laser line to obtain a first function;
step S104: a second determination step of determining a third function according to the first function and a second function, wherein the second function is a distance measurement function between the theoretical position and a predicted position of the welding gun, and the third function is a loss function between the predicted position and the theoretical position of the welding gun;
step S105: a third determination step of determining the predicted position of the welding gun when the third function converges to be a gun alignment position of the welding gun, and performing welding according to the gun alignment position of the welding gun; and step S106: repeatedly executing the first determination step, the processing step, the second determination step and the third determination step, until the welding of all weld passes of the weld seam is completed.
The device herein may be a server, a PC, a PAD, a mobile phone, etc.

### Embodiment 18

The present disclosure further provides a computer program product, which, when executed on a data processing device, is applicable to executing a program that is initialized with at least the following method steps:
Step S101: an acquisition step of acquiring an image of a groove of a weld seam to obtain a groove image;
Step S102: a first determination step of determining an ROI of a theoretical position according to the groove image, wherein the theoretical position is a theoretical position of a welding gun for welding a current weld pass to the groove, the ROI at least includes a laser line, and the laser line is emitted from a laser sensor of the welding apparatus and is formed by aligning the laser of the groove;
step S103: a processing step of at least fitting the laser line to obtain a first function;
step S104: a second determination step of determining a third function according to the first function and a second function, wherein the second function is a distance measurement function between the theoretical position and a predicted position of the welding gun, and the third function is a loss function between the predicted position and the theoretical position of the welding gun;
step S105: a third determination step of determining the predicted position of the welding gun when the third function converges to be a gun alignment position of the welding gun, and performing welding according to the gun alignment position of the welding gun; and
step S106: repeatedly executing the first determination step, the processing step, the second determination step and the third determination step, until the welding of all weld passes of the weld seam is completed.

In the above embodiments of the present disclosure, the description of each embodiment has its own emphasis. For parts that are not described in detail in a certain embodiment, reference may be made to related descriptions of other embodiments.

In the several embodiments provided in the present disclosure, it should be understood that, the disclosed technical content may be implemented in other manners. The apparatus embodiments described above are merely exemplary, for example, the division of the components is only a logic function division, there may be other division manners in practical implementations, for example, a plurality of units or components may be combined or integrated to another system, or some features may be omitted or not executed. From another point of view, the displayed or discussed mutual coupling or direct coupling or communication connection may be indirect coupling or communication connection of units or modules through some interfaces, and may be in an electrical form or other forms.

The components described as separate components may be separated physically or not, components displayed as units may be physical units or not, namely, may be located in one place, or may be distributed on a plurality of units. A part or all of the units may be selected to implement the purposes of the solutions in the present embodiment according to actual demands.

In addition, the functional components in various embodiments of the present disclosure may be integrated in one processing component, or the units individually exist physically, or two or more units are integrated in one unit. The integrated unit may be implemented in the form of hardware, and may also be implemented in the form of a software functional unit.

If the integrated unit is implemented in the form of the software functional unit and is sold or used as an independent product, it may be stored in a computer-readable storage medium. Based on this understanding, the technical solutions of the present disclosure substantially, or the part contributing to the prior art, or part or all of the technical solutions may be implemented in the form of a software product, the computer software product is stored in a storage medium, and includes several instructions for enabling a computer device (which may be a personnel computer, a server, or a network device or the like) to execute all or some steps of the method in various embodiments of the present disclosure. The foregoing storage medium includes a variety of media capable of storing program codes, such as a USB disk, a read-only memory (ROM), a random access memory (RAM), a mobile hard disk, a magnetic disk, or an optical disk.

It can be seen from the above descriptions that the above embodiments of the present disclosure achieve the following technical effects:
1) The welding apparatus control method in the present disclosure includes an acquisition step of acquiring an image of a groove of a weld seam to obtain a groove image; a first determination step of extracting a laser line according to the groove image, wherein the laser line is a line formed by projecting linear structured light on the weld seam; a processing step of at least fitting the laser line to obtain a first function; a second determination step of determining a third function according to the first function and a second function, wherein the second function is a distance measurement function between a theoretical position and a predicted position of a welding gun, and the third function is a loss function between the predicted position and the theoretical position of the welding gun; a third determination step of determining the predicted position of the welding gun when the third function converges to be a gun alignment position of the welding gun, and performing welding according to the gun alignment position of the welding gun; and repeatedly executing the first determination step, the processing step, the second determination step and the third determination step, until the welding of all weld passes of the weld seam is completed. By acquiring the groove image of the weld seam in real time, the ROI including the theoretical position of a welding spot and the laser line may be determined, the loss function between the theoretical position and the predicted position is determined according to the function of the laser line, that is, the first function, and the distance measurement function between the theoretical position and the predicted position, that is, the second function, and then the gun alignment position of the welding gun is determined according to the predicted position during the convergence of the loss function, thereby achieving the purposes of finding an optimal gun alignment position of the current weld pass in real time and dynamically adjusting the welding gun, and implementing the technical effect of improving the welding quality of multi-layer and multi-pass welding of the medium-thickness plate, thus solving the technical problem of inaccurate locating of the welding gun during welding due to the fact that the welding groove of the medium-thickness plate is wide and deep.
2). The welding apparatus controller in the present disclosure includes an acquisition component, configured to perform an acquisition step to acquire an image of a groove of a weld seam, so as to obtain a groove image; a first determination component, configured to perform a first determination step to extract a laser line according to the groove image, wherein the laser line is a line formed by projecting linear structured light on the weld seam; a processing component, configured to perform a processing step to at least fit the laser line to obtain a first function; a second determination component, configured to perform a second determination step to determine a third function according to the first function and a second function, wherein the second function is a distance measurement function between the theoretical position and a predicted position of the welding gun, and the third function is a loss function between the predicted position and the theoretical position of the welding gun; a third determination component, configured to perform a third determination step to determine the predicted position of the welding gun when the third function converges to be a gun alignment position of the welding gun, and perform welding according to the gun alignment position of the welding gun; and an execution component, configured to repeatedly execute the first determination step, the processing step, the second determination step and the third determination step, until the welding of all weld passes of the weld seam is completed. By acquiring the groove image of the weld seam in real time, the ROI including the theoretical position of a welding spot and the laser line may be determined, the loss function between the theoretical position and the predicted position is determined according to the function of the laser line, that is, the first function, and the distance measurement function between the theoretical position and the predicted position, that is, the second function, and then the gun alignment position of the welding gun is determined according to the predicted position during the convergence of the loss function, thereby achieving the purposes of finding an optimal gun alignment position of the current weld pass in real time and dynamically adjusting the welding gun, and implementing the technical effect of improving the welding quality of multi-layer and multi-pass welding of the medium-thickness plate, thus solving the technical problem of inaccurate locating of the welding gun during welding due to the fact that the welding groove of the medium-thickness plate is wide and deep.

The foregoing descriptions are merely preferred embodiments of the present disclosure and are not intended to limit the present disclosure. For those ordinary skilled in the art, the present disclosure may have various changes and modifications. Any modifications, equivalent replacements, improvements and the like, made within the spirit and principles of the present disclosure, shall fall within the protection scope of the present disclosure.

1. A method for controlling welding apparatus, comprising:
an acquisition step of acquiring an image of a groove of a weld seam to obtain a groove image;
a first determination step of extracting a laser line according to the groove image, wherein the laser line is a line formed by projecting linear structured light on the weld seam;
a processing step of at least fitting the laser line to obtain a first function;
a second determination step of determining a third function according to the first function and a second function, wherein the second function is a distance measurement function between a theoretical position of a welding gun and a predicted position of the welding gun, the third function is a loss function between the predicted position of the welding gun and the theoretical position of the welding gun, and the theoretical position of the welding gun is a theoretical position of the welding gun for welding a current weld pass of the groove;
a third determination step of determining the predicted position of the welding gun when the third function converges to be a gun alignment position of the welding gun, and performing welding according to the gun alignment position of the welding gun; and
repeatedly executing the first determination step, the processing step, the second determination step and the third determination step, until the welding of all weld passes of the weld seam is completed.

2. The method according to claim 1, wherein extracting the laser line according to the groove image comprises:
determining the theoretical position according to the groove image and weld pass distribution information, wherein the weld pass distribution information is preset weld layer and pass information; and
determining that a region comprising the laser line and the theoretical position is a Region of Interest (ROI).

3. The method according to claim 1, wherein the processing step comprises:
when an optical axis of an image collection device is perpendicular to the weld seam, fitting the laser line to obtain the first function, wherein the image collection device is configured to acquire the groove image; and
when the optical axis of the image collection device is not perpendicular to the weld seam, fitting the laser line to obtain a first preparation function, and then performing affine transformation on the first preparation function to obtain the first function.

4. The method according to claim 1, wherein determining the third function according to the first function and the second function comprises:
determining the third function according to a formula L(x)=|ƒ′(x)|+αD(x−\hat{x}), wherein L(x) is the third function, ƒ(x) is the first function, α is a weight coefficient, D(x−\hat{x}) is the second function, x is the predicted position of the welding gun, and \hat{x} is the theoretical position of the welding gun.

5. The method according to claim 1, wherein the method further comprises:
in a case that the theoretical position of the welding gun and the gun alignment position of the welding gun are located on different weld passes, performing assignment on the third function; and
in a case that the theoretical position and the gun alignment position of the welding gun are located on a same weld pass, determining whether to update the gun alignment position of the welding gun according to a derivative minimum value of the first function.

6. The method according to claim 5, wherein in the case that the theoretical position and the gun alignment position of the welding gun are located on different weld passes, performing assignment on the third function comprises:
in a case that x>\hat{x}+d or x<\hat{x}−d, performing assignment on the third function according to a formula L(x)=Lₘₐₓ, wherein x is the gun alignment position of the welding gun, \hat{x} is the theoretical position of the welding gun, d is a distance between adjacent weld passes, L(x) is the third function, and Lₘₐₓ is any numerical value greater than a minimum value of the third function.

7. The method according to claim 5, wherein in the case that the theoretical position and the gun alignment position of the welding gun are located on the same weld pass, determining whether to update the gun alignment position of the welding gun according to the derivative minimum value of the first function comprises:
in a case that the derivative minimum value of the first function is less than a threshold value, updating the gun alignment position of the welding gun according to a formula \hat{x}′=arg min ƒ′(x) wherein \hat{x}′ is an updated gun alignment position of the welding gun, and ƒ(x) is the first function; and
in a case that the derivative minimum value of the first function is greater than or equal to the threshold value, not updating the gun alignment position of the welding gun.

8. The method according to claim 1, wherein performing welding according to the gun alignment position of the welding gun comprises:
converting a first coordinate into a second coordinate, wherein the first coordinate is a coordinate of the gun alignment position of the welding gun in an image coordinate system, and the second coordinate is a coordinate of the gun alignment position of the welding gun in a welding gun coordinate system; and
controlling the welding gun to move to the second coordinate for welding.

9. A controller for welding apparatus, comprising:
an acquisition component, configured to perform an acquisition step to acquire an image of a groove of a weld seam, so as to obtain a groove image;
a first determination component, configured to perform a first determination step to extract a laser line according to the groove image, wherein the laser line is a line formed by projecting linear structured light on the weld seam;
a processing component, configured to perform a processing step to at least fit the laser line to obtain a first function;
a second determination component, configured to perform a second determination step to determine a third function according to the first function and a second function, wherein the second function is a distance measurement function between the theoretical position of a welding gun and a predicted position of the welding gun, the third function is a loss function between the predicted position of the welding gun and the theoretical position of the welding gun, and the theoretical position of the welding gun is a theoretical position of the welding gun for welding a current weld pass of the groove;
a third determination component, configured to perform a third determination step to determine the predicted position of the welding gun when the third function converges to be a gun alignment position of the welding gun, and perform welding according to the gun alignment position of the welding gun; and
an execution component, configured to repeatedly execute the first determination step, the processing step, the second determination step and the third determination step, until the welding of all weld passes of the weld seam is completed.

10. A welding system, comprising:
a welding apparatus; and
a controller, in communication connection with the welding apparatus and configured to execute the control method according to claim 1.

11. The method according to claim 3, wherein performing affine transformation on the first preparation function comprises:
performing affine transformation on the first preparation function by using any of translation, rotation, scaling and beveling.

12. The method according to claim 1, wherein before performing welding according to the gun alignment position of the welding gun, the method further comprises:
filtering the gun alignment position.

13. The method according to claim 1, wherein the acquisition step comprises:
acquiring the image of the groove by using an image collection device;
or,
acquiring the groove image in real time in a welding process by using a three-dimensional linear structured light imaging system.

14. The method according to claim 1, wherein the processing step comprises:
performing denoising and center line extraction on the laser line; and
fitting the laser line that has been subjected to the center line extraction by using a high-order polynomial least square method.

15. The controller according to claim 9, wherein the first determination component comprises:
a first determination module, configured to determine the theoretical position according to the groove image and weld pass distribution information, wherein the weld pass distribution information is preset weld layer and pass information; and
a second determination module, configured to determine that a region comprising the laser line and the theoretical position is an ROI.

16. The controller according to claim 9, wherein the processing component comprises:
a first processing module, configured to: when an optical axis of an image collection device is perpendicular to the weld seam, fit the laser line to obtain the first function, wherein the image collection device is configured to acquire the groove image; and
a second processing module, configured to: when the optical axis of the image collection device is not perpendicular to the weld seam, fit the laser line to obtain a first preparation function, and then perform affine transformation on the first preparation function to obtain the first function.

17. The controller according to claim 9, wherein the second determination component comprises:
a fourth determination module, configured to determine the third function according to a formula L(x)=|ƒ′(x)|+αD(x−\hat{x}) wherein L(x) is the third function, ƒ(x) is the first function, α is a weight coefficient, D(x−\hat{x}) is the second function, x is the predicted position of the welding gun, and \hat{x} is the theoretical position of the welding gun.

18. The controller according to claim 9, wherein the controller further comprises:
an assignment component, configured to: in a case that the theoretical position of the welding gun and the gun alignment position of the welding gun are located on different weld passes, perform assignment on the third function; and
a fourth determination component, configured to: in a case that the theoretical position and the gun alignment position of the welding gun are located on a same weld pass, determine whether to update the gun alignment position of the welding gun according to a derivative minimum value of the first function.

19. The controller according to claim 18, wherein the assignment component comprises:
an assignment module, configured to: in a case that x>\hat{x}+d or x<\hat{x}−d, performing assignment on the third function according to a formula L(x)=Lₘₐₓ, wherein x is the gun alignment position of the welding gun, \hat{x} is the theoretical position of the welding gun, d is a distance between adjacent weld passes, L(x) is the third function, and Lₘₐₓ is any numerical value greater than a minimum value of the third function.

20. The controller according to claim 18, wherein the fourth determination component comprises:
an updating module, configured to: in a case that the derivative minimum value of the first function is less than a threshold value, update the gun alignment position of the welding gun according to a formula \hat{x}′=arg min ƒ′(x) wherein \hat{x}′ is an updated gun alignment position of the welding gun, and ƒ(x) is the first function; and
a third processing module, configured to: in a case that the derivative minimum value of the first function is greater than or equal to the threshold value, not update the gun alignment position of the welding gun.
